(19) United States
(12) Patent Application Publication
(10) Pub. No.: US 2008/0109470 A1
(43) Pub. Date: May 8, 2008

(54) Method to enable the heartbeat beacon for homeland security and homeland defense interoperability

(76) Inventor: Steven James McGee, Oceanport, NJ (US)

Correspondence Address: Steven James McGee, 82 Sea Girt Avenue, Oceanport, NJ, 07757, US

(21) Appl. No.: 11/601,035

(22) Filed: Nov. 17, 2006

Related U.S. Application Data
(63) Continuation-in-part of application No. 10/709,358, filed on Apr. 29, 2004, now abandoned.
Application No. 10/709,358 is a continuation of application No. 10/708,000, filed on Jan. 30, 2004, now abandoned.
Application No. 10/708,000 is a continuation of application No. 10/605,144, filed on Sep. 11, 2003, now abandoned.

(51) Int. Cl. G06F 17/00

(52) U.S. Cl. 707/102

(57) ABSTRACT

One of the DHS's top three goals is (enabling) “A national common operating picture for critical infrastructure”. A congressional directive states “nothing less than network centric homeland security akin to network centric warfare”. The Heartbeat Beacon addresses the interoperability challenge where unique Federal/military situational awareness (SA) systems and Telco networks supporting First Responder public safety systems agree on common settings of three common denominators: (1) TCP/IP heartbeat protocol, system heartbeat, heartbeat beacon, beacon frames . . . (2) heartbeat (XML) messages that convey network configuration data (e.g., router management information databases—MIBs/multicast group subscriptions that can be implemented via transponder beacon technology that increases/decreases the multicast radius corresponding to the DHS threat condition criteria) (3) Common Alert Protocol (CAP) child schemas and/or data islands embedded in the CAP schemas with the option to code small data files as Efficient XML to accommodate extremely low bandwidth connections used by airborne or ground mobile units. When the DOD's system integrators and the world's public safety Telco network providers agree on these three common denominators/building blocks, direct collaboration based on consistent timing of events and common symbology will be achieved. A common symbol set will improve high level emergency action center & muddy boots (tactical) collaboration. Web standards verses decades old military message standards or hybrid solutions limit us to 30 second web screen scrapes that are not useful reacting to 9/11 scenarios. “Timing is everything”.

SEQUENCE LISTING
See diagram 1, diagram 2, diagram 3, and table 1 of this document. Different scenarios and different situations stimulate different work flow logic and filter logic activation as well as different message sets that are impractical to represent in a single document. Military systems of systems testing comprise hundreds if not thousands of mission threads (analogous to commercial business logic) shown in state, flow and sequence diagrams. Different scenarios flow differently through the enterprise architectures which are different. Speaking to diagram 3, the Heartbeat Beacon in system view, a generic topology was used vice architecture to represent a generic, universally applicable methodology that will be implemented across n complex systems in an application, product, and operating system neutral method. Diagram 1 is a replication of the Army's Army Battle Command System Force XXI Battle Command Brigade

### CROSS-REFERENCE TO RELATED APPLICATIONS

This application is a continuation-in-part application of U.S. patent application Ser. No. 10/709,358, filed 29 Apr. 2004, the contents of which are hereby incorporated by reference herein. U.S. patent application Ser. No. 10/709,358, filed 29 Apr. 2004 claims the benefit of U.S. patent application Ser. No. 10/605,144, filed 11 Sep. 2003 and U.S. patent application Ser. No. 10/708,000, filed 30 Jan. 2004, the contents of which are hereby incorporated by reference herein.

### STATEMENT REGARDING FEDERALLY SPONSORED RESEARCH OR DEVELOPMENT

The Department of Homeland Security forwarded this method to enable the Heartbeat Beacon to the federal government's Technical Support Working Group—TSWG who tabled this inventor's proposed invention on 11 Jan. 2006. The TSWG is comprised of board members from the major anti-terrorism agencies (e.g., FBI, CIA, NSA, DHS, DIA and DOD).

### NAMES OF THE PARTIES TO A JOINT RESEARCH AGREEMENT

Not Applicable

### INCORPORATION-BY-REFERENCE OF MATERIAL SUBMITTED ON A COMPACT DISK

Not Applicable

### BACKGROUND OF THE INVENTION

### Field of the Invention

This invention is a second continuation of two previous method patent applications relating to homeland defense and homeland security in the areas of Situational Awareness (SA), emergency alerting and response telecommunications interconnecting a plurality of TCP/IP networked systems reapplying military unique procedures relating to “network centric warfare” in a methodology that is interoperable with commercial counterpart e9-1-1, mesh network, telemetric and home awareness systems that rely on the underlying data transfer capabilities of the TCP/IP heartbeat/heartbeat beacon function that the military employs to enable “spontaneous (re) integration” task (re) organization among disparate, adhoc military organizations/commercial domains in times of disaster, crisis and war/terrorism.

The unique nature of this invention rests on the fact that the military Situational Awareness (SA) “system of systems” and commercial counterpart systems make use of the open or unused heartbeat/beacon frames to gather military unique data types (e.g., organizational identification number known as the ORG ID), to send heartbeat eXtensible Markup Language—XML network (re) configuration messages (schemas/forms as common building blocks—differently . This invention describes procedures derived from the military's Force XXI Battle Command Brigade and Below—FBCB2 and its satellite adapted variation Blue Force Tracker—BFT adapted to be interoperable with DHS/civilian emergency response systems. A simple way of demonstrating the differences that exist between the military derived procedures and commercial systems is to reference U.S. Pat. No. 6,028,514 dated Feb. 22, 2000 titled “Personal Emergency Safety Warning System and Method”. This patent describes simply and clearly both the satellite and terrestrial communications, handheld radios/personal security devices and supporting system infrastructure that is common between both the military and commercial systems and will not be duplicated by this application for brevity.

It is important emphasize that the TCP/IP heartbeat sub-protocol is referred interchangeably throughout the telecommunications industry as the “system heartbeat”, “heartbeat beacon”, “the beacon”, “beacon frames” “system heartbeat”, “host heartbeat”, “heartbeat chunks”, “heartbeat/beacon” . . . , that are semantic variations of the same system functionality that this invention rests. For example the “host heartbeat” involves “the use case where a host, the client using either IPv6 or IPv4, sends notifications of its aliveness/acknowledgement to a server. This function is used for server management and failover situations. The heartbeat commands include extension commands that make use of used space on the additional lines in the packet/beacon frames that the client can send along information about CPU load, node id, clock reading, and time slice assignment, for synchronization and network topology maintenance; e.g., the “heartbeat interval””.

Performing a patent search, the closest patent applications discovered using the text string “heartbeat”+protocol+messaging is the below cited application. It cites the heartbeat protocol in context with network keep alive functions/messages that this inventor does not mention once in this application.

U.S. Patent Application 20020164999

Kind Code Al Johnson, William J. Nov. 7, 2002

System and method for proactive content delivery by situational location

U.S. Pat. No. 6,028,514: Date: Feb. 22^{nd}, 2000

Jerome H. Lemelson, Robert D. Pederson

Personal Emergency Safety Warning System and Method

The above patent does not cite the heartbeat, the beacon, the heartbeat beacon in any combination.

According to the company DeviceScape's glossary for Beacon; Beacon frames provide the “heartbeat” of a wireless local area network or WLAN, announcing the existence of the network, and enabling stations to establish and maintain communications in an orderly fashion. It carries the following information (some of which is optional): the timestamp, the beacon interval, the Service Set Identifier (SSID), the Basic Rate Set, the optional Parameter Sets indicates features of the specific signaling methods in use (such as frequency hopping spread spectrum, direct sequence spread spectrum, etc.), the optional Traffic Indication Map (TIM) identifies stations, using power saving mode, that have data frames queued for them.

According to the Controller Area Network—CANopen organization that is comprised of hundreds of corporations worldwide, “the Heartbeat protocol is for error control purposes and signals the presence of a node and its state. The Heartbeat message is a periodic message of the node to one or several other nodes. It indicates that the sending node is still working properly”.

According to an article describing wireless LAN beacons on Wireless Planet's site, “the beacon frame, which is a type of management frame, provides the “heartbeat” of a wireless LAN, enabling stations to establish and maintain communications in an orderly fashion”.

The intent of this discussion is to establish that the title of this invention has been changed from the previous application's title “method to enable Heartbeat e9-1-1” to “Method to enable The Heartbeat Beacon for Homeland Security and Homeland Defense Interoperability” to acknowledge further research into the nature of the invention that in fact includes mesh networks, public safety and e9-1-1 systems, beacon systems and protocols, Home Awareness systems, as well as military unique situational awareness systems.

This method patent application refers to the above cited U.S. Pat. No. 6,028,514 for its graphical depiction of the system describing common infrastructure components such as Global Positioning satellite and terrestrial radio networks common among both military and commercial telecommunication systems.

Network centric warfare procedures and methodology are applied to the military's organic communications but not the communications that it leases that comprises up to 80% of the military's total telecommunications portfolio. The commercial sector provides approximately 85% of our nation's infrastructure. The military's core situational awareness systems and our emergency systems rely on the heartbeat protocol and heartbeat XML messages albeit with different (military unique/XML message hybrid) schema structures, event refresh timing, and symbol sets. This application method to enable the Heartbeat Beacon together with its two preceding method patent applications describes a methodology to achieve interoperability and operational synergy between military “system of system” equipped units and disparate commercially supported units improving interoperability while increasing the military's network centric warfare's utility and efficiency.

One of the DHS's top three long term goals is (enabling) “A national common operating picture for critical infrastructure”. A congressional directive states “nothing less than network centric homeland security akin to network centric warfare”. A Department of Homeland Security document describing state interoperability funding dated May 2006 states on page 32: a goal to “Improve capacity to include Emergency Medical Service responder status management and vehicle location as an extension of the HEARTBEAT computer aided dispatch system”.

The military provides 20% of its network capacity in South West Asia. The remaining 80% is leased commercial (portfolio) assets. Applying network centric warfare procedures to 100% of their portfolio is not only Clinger-Cohen Act compliant (see response to the USPTO non final rejection mailing for application Ser. No. 10/605144). The unique nature of the second filing (Ser. No. 10/708000) is describing a common, consistent, standard method of applying the heartbeat protocol and heartbeat messages/message schemas that are Common Alert Protocol compliant child schemas and/or data islands embedded in the parent and or child schemas depending on the situation/scenario (business logic/mission threads) involved as implemented across x complex systems, y federal, state and local contracts, and z product and system types in a universal, non-proprietary non military unique method.

Method to enable the Heartbeat Beacon interoperability hinges on the heartbeat protocol and heartbeat XML message/schema network centric warfare common denominators/building blocks commercializing military methodology to IP multicast-broadcast through the world's telecommunications emergency/disaster alerting infrastructure (e.g., e9-1-1 Public Safety Access Points or PSAPs) via domain specific (e.g., mil., gov., org., com) child schemas and or military data elements (Agile Delta Efficient XML encoded—situation dependent—residing in data islands embedded in parent Common Alert Protocol—CAP schemas. An alternative or equivalent to embedded data islands is the military's use of AgileDelta's Efficient XML to process and distribute small data files to “fast movers” e.g., jets and mobile computer devices (e.g., FBCB2 equipped platforms and soldier carried ruggedized handheld devices).

This invention describes a method whereby network centric warfare (NCW) procedural methods currently applied to military networks in a proprietary method (e.g., Tactical Data Links or TADIL formats are military developed, unique binary formats as described in method patent application Ser. No. 10/605144 “method to commercialize structured military messaging”) are commercialized then reapplied to commercial emergency networks (e.g., E9-1-1 Public Safety Answering Points—PSAPs, mesh networks, telemetrics systems e.g., OnStar & beacon transponder technologies such as SABRE, SENTINEL, Sea Gull, and the Flux Beacon as described later in this paper.

The base application Ser. No. 10/605144 describes a methodology where military unique FFIRN (field item reference numbers and FUDNS (field unit number designators) that are three and four digit codes are converted to corresponding DOD Discovery Metadata Standard—DDMS XML tags; these tags as part of XML forms/messages/schemas (only different in name and in structure) will be processed by Commercial Off the Shelf (COTS) products like Groove or Biztalk or any product with an intrinsic forms engine/XML parser. Symbolic interoperability and interoperable data exchange is Ser. No. 10/605144's intent.

The first continuation method patent application Ser. No. 10/708000 “method to enable a Homeland Security Heartbeat” describes methodology enabling consistency of event timing/network configuration data harvesting across n complex systems for event data distribution and network (re)configuration and reconstitution based upon the TCP/IP heartbeat protocol that is a low level publish—subscribe mechanism in widespread use by both military and commercial systems—applied differently (e.g., the heartbeat data collection is set at different temporal rates).

Application Ser. No. 10/708000 adds through the use of the heartbeat protocol's intrinsic timing function and data harvesting function adds temporal consistency and the ability to “spontaneously re-integrate” based on the military's system development enabling organizational mobility via multicast/unicast router/switch groups managed by Management Information Bases—MIBS.

Application Ser. No. 10/708000 describes a methodology whereas router-switch multicast groups for tactical-strategic military systems, first responder and commercial event-alert broadcast services are updated at heartbeat protocol set predefined intervals (e.g., milliseconds, seconds, & minutes). This multicast descriptive group data stored in Management Information Bases (MIBS) in router/switches is updated by data gathered by the heartbeat protocol as a type of publish subscribe mechanism. This network configuration data is then distributed by extensible Markup Language—XML heartbeat schemas/messages/forms (functionally the same) that are used to reconfigure unicast—multicast network parameters such as router—switch management information bases (MIBs).

According to the AFCEA Signal Magazine reference below, one of the key systems formats is part military unique (Variable Message Format) and part XML schema that will not be directly exchanged (e.g., messaging) with our commercial emergency notification network (e.g., PSAPs). DOD's application of the heartbeat protocol & heartbeat messages:
Armed Forces Communication's Electronics Association’ AFCEA's SIGNAL Magazine article “Defense Knowledge Management Hinges on Compatibility” May 2005. “Using Web services technology and a laptop computer, these researchers separated the Force XXI Battle Command Brigade and Below—FBCB2 application from Blue Force Tracking data according to an established schema. An extensible markup language (XML) wrapper exposed the discovery metadata to a portal for updating every thirty seconds”.

Thirty second web server refresh rates are insufficient for engagement of objects traveling towards targets at speeds approaching or exceeding mach—hence the need for direct data/message (binary) XML schema exchanges between military and first responder situational awareness systems. The most pressing case is the need to exchange data between Federal Aviation Administration PSAP supported networks processing NORAD telemetry data directly with military units of action (i.e., military jets)—described by the September 11^{th} “9/11” scenario.

The inventor will now list precedent commercial initiatives on which to achieve operational synergy with military derived situational awareness methodology.

AT&T has developed a movement detection process that it calls the “Heartbeat Solution.” AT&T has designed its Voice over Internet Protocol—VoIP telephone adapters to enable it to detect when an adapter has been disconnected and then reconnected. Once the Heartbeat Solution detects a reconnection, “the AT&T network will temporarily suspend the customer's service and will post a message at the customer's web portal directing the customer to confirm the existing registered location address or register a new location address.”

The Emergency Management Network (EMnet) in use in a dozen states “generates Nadat HEARTBEAT messages to maintain lost connections. EMnet/Emergency Action System (EAS) messages will be delivered to broadcasters within seconds using the secure satellite delivery system”.

During the 2006 National Football League Super Bowl, an approach to fuse sensor data was demonstrated by the 51st Michigan National Guard involving the Transducer Data Exchange Protocol(TDXP). TDXP is implemented over IETF 1451 that interact with Management Information Bases (MIBS) that rely on the heartbeat protocol.

Raytheon/XM Satellite Radio's approach is described “NYC Firefighters plan a military approach to command and control”. By viewing information displayed as an electronic map, fire department commanders will be able to move firefighters, equipment and emergency medical teams around in much the same way military commanders shift troops and equipment around a battlefield”.

The City of New York recently awarded a 500 million dollar wireless infrastructure contract to firms that have selected the Universal Mobile Telecommunications System or UMTS that applies the heartbeat to “track users activities”.

Cisco Systems Communications Interoperability and Safety Systems—IPICS is “based on proven IP standards” the Cisco IPICS server is monitored using a “heartbeat”. “IPICS software uses XML messaging schemas to identify types of communications devices managed by the system.”

Eaton Inc's “Home Heartbeat” as the “World's First Home Awareness System” as an example of the technology backed by the ZigBee Alliance of 100 companies employing the ZigBee mesh networking protocol that makes use of the underlying heartbeat protocol. The inventor believes that this community is building a logical bridge to exchange situational awareness data in our neighborhoods with the military terrorist information producing systems that also make use of the heartbeat protocol. In addition to receiving alerts that a situation like washers overflowing or the garage door is left open when the occupants are scheduled away (an open invitation to terrorist activity), the owners and appropriate first responders will be alerted and situational awareness maps updated. Neighborhoods will be alerted in mass is say an airplane like the one that was downed in rural Pennsylvania is headed for a more populated area.

Lockheed Martin/Qualcomm & SPRINT-Nextel's Department of Justice Integrated Wireless Network (IWN) bid necessarily involves Qualcomm's role in the development of Blue Force Tracking (BFT) in the Balkans. Reason being, changing their approach would be expensive and would impact interoperability with key military situational awareness systems e.g., FBCB2, Blue Force Tracking, Joint Blue Force Situational Awareness & Land Warrior that are still being fielded and will be in the inventory until well into the next decade.

Geospatial/Dispatch systems like Intergraph's Computer-Aided Dispatch System (I/CAD) make use of Telco location data: Automatic address input via ANI/ALI (automated number/location information) & Automatic location verification. Vehicle positions from an AVL system auto displayed on I/CAD map on 18 military installations.

Telco e9-1-1 PSAP's processing NORAD aircraft tracks and DOD SA systems processing aircraft tracks do not directly exchange messages/XML schema's with each other Given that up to 80% of a unit's communications will be commercially leased, this implies that only 20% of a force's network centric warfare supporting assets (router/switches) are employing network centric warfare practices and that if these military assets were not available, soldiers would not be able to fight as they have trained nor would they be able to discuss an event with First Responder counterparts given different temporal data collection, screen refresh rates, and geospatial symbol sets.

The heartbeat protocol and heartbeat network reconfiguration messages are part of Defense Information System Agencies (DISA) Network Centric Enterprise Services (NCES) Technology Development Strategy Version Two dated 26 May 2004. The heartbeat protocol as part of DISA's Network Centric Enterprise Services Technical Plan, Telco regulations, and bell-weather IT firms public safety strategies, is a simple but effective means to improve interoperability leveraging the power of network centric warfare.

The intent of the above listed heartbeat/heartbeat beacon/beacon frame precedents is that more modern protocols are being devised as well as current products/complex systems yet they still rely on the heartbeat protocol/heartbeat messages. Distributed Instruments states that “TDXP was designed and built for a Service Oriented Architecture SOA” supporting direct interoperability between layer one and two (mobile, chaotic environments) with enterprise level SOA(s) that implement system wide heartbeat protocol and heartbeat mechanisms to monitor supported application and system health.

While the heartbeat protocol mechanism is not necessarily needed to time data exchanges (given the network timing protocol (NTP), the heartbeat protocol is currently and will continue to be a multi industry standard among situational awareness (SA) alerting and failover systems until well into the next decade—especially on the military side of the equation where scheduled replacement systems such as Future Combat Systems (FCS) will not be fully fielded until 2014 referencing the current military schedule. Once fielded, systems typically remain in the portfolio for a decade or more. Point being is that the heartbeat protocol and XML heartbeat message/schema's/forms will be viable for the next decade or longer.

Below is a representative sample of transponder beacon technologies that make use of the heartbeat beacon/beacon frames that can be leveraged in enabling the Heartbeat Beacon:

ADS-B: Automatic Dependent Surveillance—Broadcast: ADS-B messages include fields for avionics self-reporting of the integrity of ADS-B position information & proximity alerts.

CASM: Communications Assets Survey and Mapping Tool Gap analysis package that provides a single database to collect info about land mobile radio systems, interoperability methods and how they are used by public safety agencies. CASN displays data with tools to visualize interoperability gaps via the DHS SAFECOM Interoperability Continuum framework.

FLUX Beacon: A Forensic Time Machine for Wireless Networks: enables a monitoring infrastructure for forensic data collection, storage and analysis supports the recording and retrieval of traffic signatures and environmental observations as a source of network evidence.

MxRRM Radio Resource Management in multi standard environments: Beacon on one system for all, assuming this one has nearly ubiquitous coverage like GSM. Using a priority scheme to define an order how to scan. If there is an incoming call for a specific user being reachable via more than one mobile network.

SABRE: Situational Awareness Beacon Response: battle group situational awareness system that is capable of determining the location of beacon-equipped platforms tanks, ships, aircraft, . . . , Using GPS, SABER produces accurate position and platform identification data sending it to tactical users via C2 comm nodes. Functions in an “intent to shoot” and “friendly ID” query and response mode.

Sea Gull: Server Heartbeat strategy used to maintain routing and object state using <1% minimal network resources. Multicasts with increasing radius in response to user defined threshold settings. Server Heartbeat: “Keep-alive” beacon along each forward link. Sea Gull applies an increasing period (decreasing frequency) with the routing level. Data-Driven Server Heartbeat's “Keep-alive” Multicast to all ancestors with an object pointer

Sentinel Beacon: “Command Station” a ruggedized PC that receives the data transmitted from the beacons and processes it to produce location and track information for the incident commander. The Sentinel Beacon system is designed to work as a “mesh network” so that a beacon out of range of the command station can have its data relayed by other beacons.

Summarizing this section, this second continuation application Ser. No. 10/09358 is a continuation of Ser. No. 10/70800 that is a continuation of patent application Ser. No. 10/605144. It describes a methodology to reapply network centric warfare procedures removing the military proprietary structured military message formats described in Ser. No. 10/605144 via standard XML schema structures (CAP child schemas and/or data islands in DDMS format) with commercial leased systems. This methodology improves interoperability in terms of symbology, EAC and smartphone screen refresh rates and timeliness of alerts. This invention describes a methodology whereby individuals or groups data subscriptions are updated via a common refresh rate for display on Emergency Action Center (EAC) screens and personal handheld wired and wireless mesh network supported devices (e.g., smart phones, personal digital assistants) applying a common symbology set as described by accessing common federal XML repositories described by common syntax e.g., Service Provisioning Markup Language (SPML) and Web Services Resource Framework (WSRF) that maintains state information essential in low bandwidth, mobile environments. Disparate systems access this configuration and user subscription data from supporting (DISA) Service Oriented Architectures (SOA) that implement system wide heartbeat services via heartbeat XML messages.

### DESCRIPTION OF RELATED ART

### Brief Summary of the Invention

### Principle Operation of the Invention:

The Heartbeat Beacon is a method to adapt the battlefield proven Force XXI Battle Command Brigade and Below (FBCB2) and the satellite network adapted Blue Force Tracker—BFT for commercial/First Responder use. Since FBCB2/BFT is based upon workflow logic data/forms exchanges distributed by TCP/IP internet unicast, multicast groups—i.e., Verizon's VCAST, the idea is to replicate war proven procedures to organize and maneuver (military speak) the commercial leased portion of the network that can be up to 80% commercially leased even in South West Asia (SWA). The Heartbeat Beacon describes a methodology to “maneuver the network” (change router databases and supporting directory services to support maneuvering units) enhanced by beacon transponder technology & made interoperable by adapting the procedures to the world wide OASIS standards body & presidential ratified Common Alert Protocol—that is not at the time of this application linked with military NCW data exchanges hence Heartbeat Beacon's notion of CAP child schemas to account for (commercial) domain specific business rules analogous to structured military message mission threads. Heartbeat Beacon methodology connects military domains with commercial/first responder chop chains (workflows). Example: NORAD track data processed by e9-1-1 Public Safety Answering Points—PSAPS is distributed only through the 80% of the commercial network—not the 20% of the military organic assets where systems controlling fast movers & air defense assets operate which is an obvious and pressing operational disconnect e.g., the 9/11 scenario.

Other operational goals of this application include:
Will establish a common data collection time stamp among n alert and emergency responder systems reducing “swivel chair analysis in high level emergency/military command control centers”
Using XML tags vice time honored military proprietary FFIRNS and FUDNS that First Responder systems cannot process will improve common symbology used across N complex systems & improve on the ground/muddy boots collaboration in an “apples to apples, oranges to oranges” method
The use of Efficient XML (a form of binary XML encoding) will resolve the issue of rich encoding (e.g, Microsoft Office Binary Large Object or BLOB encoding on the “upper tactical internet” to users on the “lower tactical internet” who see mangled & disjoint sync matrixes that are Microsoft Excel spreadsheets on the commercial side of the equation. Structured military messaging has no convention for richly encoded documents.
Common timing of target data followed by the subsequent direct exchanges of beacon transponder compliant efficient XML binary encoding or Qualcomm's Binary Runtime Environment for Wireless—BREW etc., vice traditional binary encoded structured military messages will result in faster than 30 second web server/Army Information Server derived screen scrape transactions too slow for targeting/engagement.
Brings to bear university & commercial domain beacon transponder & other tech to the war effort.
The Heartbeat Beacon leverages the military's Network Centric Warfare (NCW) operational procedures that hinge on the heartbeat protocol & heartbeat network management messages as applied thru the world's SATCOM transponder beacon & Telco network Public Safety Answering Points (PSAPs) as commercially leased thru key federal contracts (GSA NETWORX, GSA Alliant, DOJ IWN, DHS EAGLE, DHS FirstSource & DISA Encore II).

### BRIEF DESCRIPTION OF THE SEVERAL VIEWS OF THE DRAWINGS

FIG. 1 is a schematic showing the Commercial Framework Equivalent of Network Centric Warfare Tactics, Tools & Procedure;

FIG. 2 is a schematic showing FBCB2/Army Battle Command System Heartbeat aided procedure for Situational Awareness; and

FIG. 3 is a schematic showing the Heartbeat Beacon System View.

### DETAILED DESCRIPTION OF THE INVENTION

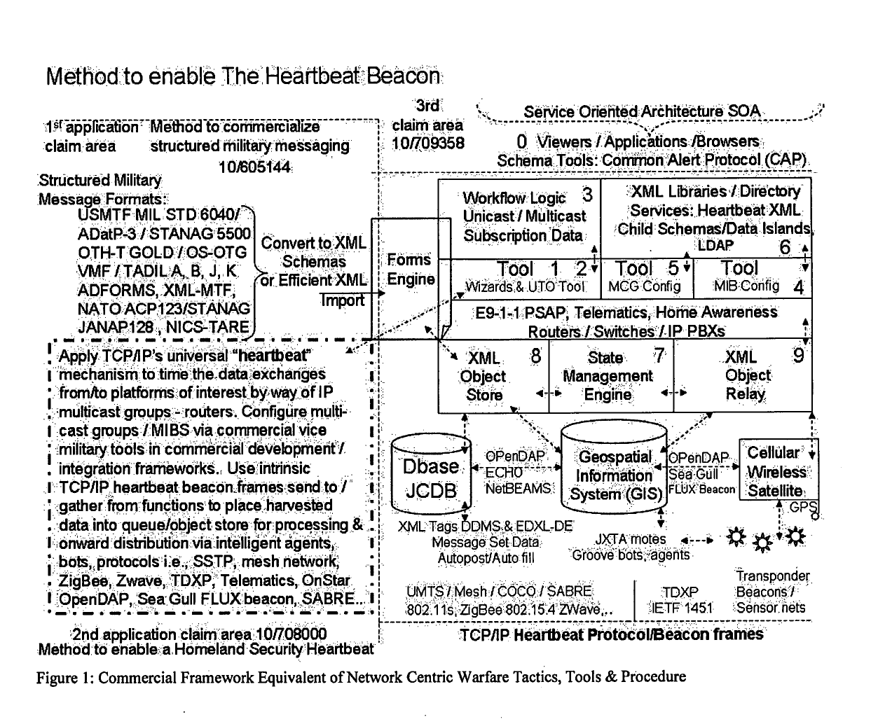

Graphic FIG. 1 “Method to Enable the Heartbeat Beacon” is labeled and divided into three distinct areas corresponding to the inventor/SAW Concepts method patent applications. This graphic is derived from the same template applied by the previous two applications. The upper left hand corner labeled 1^{st} claim area “method to commercialize structured military messaging” that is the title of method patent application Ser. No. 10/605144. The lower left hand corner is labeled “2^{nd} claim area corresponds to application number Ser. No. 10/708000 “method to enable a homeland security heartbeat”. The claim area corresponding to this application is the area on the right hand side of the diagram below and above the dashed lines. Describing each claim area in turn:

Claim area one Ser. No. 10/605144: As structured military proprietary military message formats as generated by the Ground Tactical Communications Server—GTCS (8) product are converted to commercial standard XML tags in schema's the underlying government developed message parsers will be replaced by parsers that are intrinsic to commercial products (diagram 2, forms engine icon). The inventor used Groove Networks Groove's software framework as an example. Functionality of this section is fully described by Ser. No. 10/708000.

As the military's FFIRN (field reference numbers) and FUDs (field unit designators) that are three and four digit codes are converted to corresponding XML tags, those tags as part of XML form/messages will be processed by products like Groove or Biztalk or any other product with an intrinsic forms engine/XML parser. Symbolic and data exchange interoperability is the theme of application Ser. No. 10/605144.

2^{nd} claim area Ser. No. 10/708000—first continuation of Ser. No. 10/605144: The gathering of data/intelligence/network configuration data by the heartbeat protocol is timed consistently by the heartbeat protocol between like organizations/units. A military medical unit at the scene of a disaster or event would collaborate most efficiently if its counterpart Emergency Medical Service (EMS) team's event refresh rate were consistent to the military's (e.g., every five, fifteen minutes or faster/slower given the operational scenario/Standard Operational Procedure of the unit/organization). Too slow event refresh rates result in data that in the military system used as a template by the inventor (Force XXI Battle Command Brigade and Below—FBCB2) is described as “stale”. Event refresh rates that are too frequent (e.g., milliseconds, 5 seconds . . . ) will saturate low bandwidth links indicative of tactical/chaotic wireless network environments.

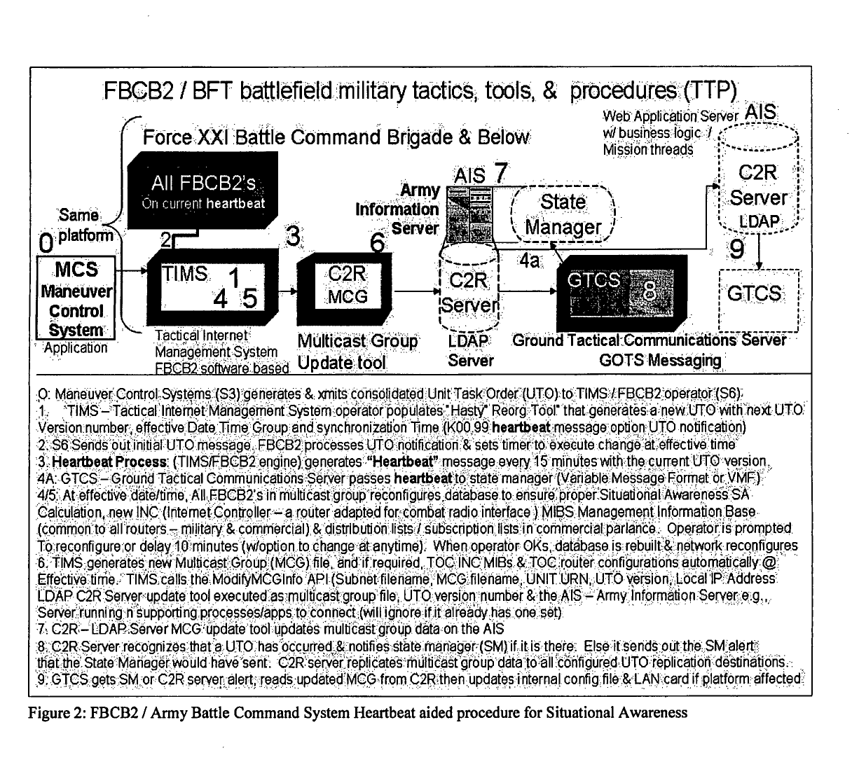

Method patent application Ser. No. 10/709358—2^{nd} continuation of Ser. No. 10/708000: The heartbeat protocol as a low level data harvester gathers network configuration data (e.g., current IP lease, multicast group participation, state information such as moment greater than 50 meters, at halt, off line, or straggler . . . ) that is gathered and forwarded by any newer, more efficient products or systems. Once multicast subscription group(s) state data is consolidated, data is consolidated by the tactical equivalent of the corporate system administrator or the S-6 in military parlance. As described in application Ser. No. 10/708000, the Tactical Internet Management System or TIMS (FIG. 2 number 1,4,5) is used to configure router management information bases (MIBS) and associated multicast entries describing the grouping of organizations (units) for missions (Unit Task Order see FIG. 2, number 0).

The S-6/system administrator then broadcasts the updated network configuration data in the form of (K00.99 Variable Message Format) heartbeat messages to higher, lower and adjacent organizations refreshing router/switch unicast/multicast subscriptions—FIG. 2, number 6. On the military side of this procedural method, situational awareness data subscriptions are updated and units tether and untether to network nodes as they maneuver. A similar process occurs on the commercial side of this methodology as cell phone/smart phone/wireless laptop users tether and untether to cell tower nodes—differently i.e., different heartbeat protocol data collection-distribution rates and different heartbeat XML message schema structures).

Method patent application Ser. No. 10/709358 by citing Emergency E9-1-1 cell phones and smart phones is claiming that network centric warfare methodology/procedures commercially emulated by E9-1-1 Public Safety Answering Points—PSAPs will increase the benefits of this key federal initiative while improving military to first responder interoperability and operational consistency.

Data elements derived from structured military messaging as processed by commercial forms engines (FIG. 2) with underlying message parsing processes provide the ability to resolve down to the individual platform level symbolically vice a geographic area of interest as in the Common Alert Protocol—CAP.TCP/IP's heartbeat mechanisms provide a common and consistent send to/get from plus timing/trigger function for data harvesting and exchanges adding DOD Data DDMS tagged data islands to the CAP and/or creating child domain specific schemas that will provide the basis of a international Heartbeat Beacon service available on a subscription basis such as neighborhood watch programs equipped with GPS smart phones, handhelds, laptops and computer devices.

Use of the TCP/IP heartbeat protocol and heartbeat XML messages as common denominators/common building blocks as a means to establish a common structure to improve interoperability and consistency among and between complex systems is the intent of the Heartbeat Beacon (see diagram 3 top left). The Heartbeat Beacon addresses the interoperability challenge where unique Federal/military situational. awareness (SA) systems and Telco networks supporting First Responder public safety systems agree upon the common, consistent and interoperable settings of common denominators such as the TCP/IP heartbeat protocol and heartbeat (XML) messages that convey network configuration data (e.g., router MIBs multicast group subscriptions). When the DOD and the world's Telco networks agree on common network (re) configuration procedures based on these common denominators (heartbeat protocol and heartbeat eXtensible Markup Language (XML) Emergency Data Exchange Language Distribution Element (EDXL-DE) formatted schemas), direct data/message exchanges and collaboration based on common timing of events and common symbology will be possible.

This application claims that Heartbeat Beacon described and graphically depicted methodology is key to establishing an (inter) National Common Operational Picture—NCOP. Symbolic interoperability and interoperable, temporally synchronized data exchange, adhoc spontaneous integration is the focus area of this series of method patent applications.

The heartbeat protocol and heartbeat XML schemas/messages as designed by the committees and organizations developing homeland defense/homeland security strategies will enable data sharing/workflows between the citizens of our homeland and first responders as consumers of situational awareness information gathered by our military(s)—provided that they arrive at agreement on the frequency that the heartbeat gathers network configuration data and places that data in queues, files structures, object stores and provided that the heartbeat network configuration XML messages apply common structures and application methodology.

This invention describes a method whereby network centric warfare (NCW) procedural methods currently applied to military networks in a proprietary method (e.g., Tactical Data Links or TADIL formats are military developed, unique binary formats as described in method patent application Ser. No. 10/605144 “method to commercialize structured military messaging”) are commercialized then reapplied to commercial emergency networks (e.g., E9-1-1 Public Safety Answering Points—PSAPs).

This invention describes commercializing the methodology behind network centric warfare (NCW) whereby mission threads in military parlance (workflow logic/business rules) initiating message/data exchanges via unicast & multicast IP groups on the battlefield are similarly handled through the world's telecommunications Public Safety Answering Points —PSAPs so that soldiers will fight as they have trained in local neighborhoods if their supporting organic equipment is unavailable.

The base application Ser. No. 10/605144 describes a methodology where military unique FIRNs (field item reference numbers and FUDNs (field unit number designators) that are three and four digit codes are converted to corresponding XML tags, those tags as part of XML form/messages will be processed by products like Microsoft Groove or Biztalk or any other product/enterprise suite with an intrinsic forms engine/XML parser. Application Ser. No. 10/605144 method to commercialize structured military messaging is a necessary precondition to executing the two continuation applications.

The first continuation method patent application Ser. No. 10/708000 “method to enable a Homeland Security Heartbeat” describes methodology enabling consistency of event timing/network configuration data harvesting across n complex systems for event data distribution and network (re)configuration and reconstitution based upon the TCP/IP heartbeat protocol that is a low level publish—subscribe mechanism in widespread use by both military and commercial systems—albeit applied differently (e.g., the heartbeat data sampling is set at different rates).

Application Ser. No. 10/708000 adds through the use of the heartbeat protocol's intrinsic timing function and data harvesting function adds temporal consistency and the ability to “spontaneously re-integrate” based on the military's research into organizational mobility via multicast/unicast router/switch groups stored in Management Information Bases—MIBS.

Application Ser. No. 10/708000 describes a methodology whereas router-switch multicast groups for tactical-strategic military systems, first responder and commercial event-alert broadcast services are updated at heartbeat protocol set predefined intervals (e.g., milliseconds, seconds, & minutes). This multicast descriptive group data stored in Management Information Bases (MIBS) in router/switches is updated by data gathered by the heartbeat protocol as a type of publish subscribe mechanism. This network configuration data is then distributed by eXtensible Markup Language—XML heartbeat schema's/messages that are used to reconfigure unicast—multicast network parameters such as router—switch management information bases (MIBs).

This second continuation application Ser. No. 10/709358 is a continuation of Ser. No. 10/70800 that is a continuation of Ser. No. 10/605144. This invention describes a methodology whereby individuals or groups data subscriptions are updated via a common refresh rate for display on Emergency Action Center (EAC) screens and personal handheld wired and wireless devices (e.g., smart phones, personal digital assistants) applying a common symbology set as described by accessing common federal XML repositories described by common syntax e.g., Service Provisioning Markup Language (SPML) and Web Services Resource Framework (WSRF) that maintains state information essential in low bandwidth, mobile environments.

Referring to the 3^{rd} Claim area Ser. No. 10/709358 Tool area in FIG. 1 diagram's main box describing the Heartbeat Beacon as a framework: Use of TCP/IP's heartbeat mechanisms as the basis for configuring network (router Management Information dataBase—MIB) is a key mechanism to exchange situational awareness information (where am I, where are my friends, where is the threat, what, when, how fast, how often) given that multicast group subscription methodology is currently implemented by the DOD and commercial sector alike.

3^{rd} claim area Ser. No. 10/709358 Tool area (FIG. 1, numbers 1, 2, 4, 5) includes the acronym UTO—Unit Task Order. The template military situational awareness applications FBCB2 and Blue Force Tracking) apply the Unit Task Order as hierarchical depiction of unit structure showing how units are organized for operations similar to corporate wiring diagrams. UTO distribution is enabled by the use of TCP/IP's heartbeat mechanisms described in 2^{nd} claim area Ser. No. 10/708000 in terms of the heartbeat protocol's send to, get from and timer/data harvest trigger. Gathering network (re)configuration data used to update tactical/corporate organization/first responder's multicast subscription information based on unit/organizational mission posture change is key to the Heartbeat Beacon's methodology.

The commercial equivalent of the military proprietary UTO Tool (FIG. 1, number 2) composes heartbeat protocol gathered network (re)configuration data as a XML EDXL-DE formatted schema with military DDMS data as embedded islands or child schemas. Commercial equivalent UTO tools will exchange these network reconfiguration messages with military counterpart organizations. Tool functionality includes the feature to update corresponding MCG - MultiCast Group subscription data and Management Information Base (MIB)-FIG. 1, number 5. The UTO is part of the military TIMS (Tactical Internet Management System) FIG. 2, number 1.

Describing the top most two blocks in the box in the 3^{rd} claim area Ser. No. 10/709358 from left to right:

Top most left block labeled Workflow Logic/Unicast—Multicast subscription data—diagram 1 number 3: FBCB2/Blue Force Tracking/Land Warrior as the military's main situational awareness propagation systems are workflow logic instantiated by scripts, defined by filters as implemented and broadcast by unicast/multicast IP groups (5) supported by router/switches.

FIG. 1, number 6: top right block labeled XML repositories, NIEM, JXDM, DDMS, OpenGIS OGC, EDXL-DE formatted sets reference the: National Information Exchange Model - NIEM, Global Justice XML Data Model (Global JXDM), DoD Discovery Metadata Standard (DDMS), Open Geospatial Consortium—OGC. These repositories will provide XML tag repositories for the viewers/applications/browsers to formulate Common Alert Protocol—CAP schemas with Emergency Data Exchange Language Distribution Element (EDXL-DE) formatted messages with child schemas and/or DDMS formatted data islands to bridge emergency response threads between .mil, .gov, .com, .org domains.

3^{rd} claim area Ser. No. 10/709358 above the box and below the bracket labeled Service Oriented Architecture—SOA: DISA's Service Oriented Architecture (SOA) product (Amberpoint) employs an end to end heartbeat protocol, heartbeat XML message based system health monitor of the Network Centric Enterprise Service—NCES runtime environment that it is offering to all other agencies. Therefore, from foxhole to enterprise, the heartbeat protocol and heartbeat message schema exchange between DOD/military and commercial First Responder domains are key building blocks/common denominators to increase of the power of network centric warfare by enabling direct military—first responder collaboration mitigating the next (inter) national catastrophic event by improving response times, faster targeting refresh rates, common timing of event sampling and enabling consistent screen refresh rates displaying consistent symbol sets.

Expanding on the application of a Common Alert Protocol designed with child domain schemas/embedded with military DDMS tags, this invention application is asserting that the military notion of “stragglers” will suit commercial/Homeland Security domains by tracking organizations, units or high profile users. RFID tracked packages that stray from posted itineraries or routines are labeled as “stragglers”. Stragglers on a Blue Force

Tracking screen are shown as dimmed or grayed out icons as “stale” since they failed to report within established time limits.

Restructuring the Common Alert Protocol (CAP) by adding nested XML schema elements as data islands or derivative child domain CAP schemas are developed; the intent behind structured military messaging as driven by the TCP/IP heartbeat network reconfiguration process will be combined with a unified CAP structure or child structures to achieve a universal military/commercial, JIM (Joint Interagency, Multinational) domain “Heartbeat Beacon” service given North American Aerospace Defense Command—NORAD data is processed by the Public Safety Answering Points but not directly exchanged with the military fast movers (fighters) or air defense units. A recent Signal Magazine article quoted a 30 second web page refresh rate accordingly—too slow for targeting and tracking purposes.

Development of a methodology of nested CAP schema elements and/or derivative child schemas as shown to the right of the 3^{rd} claim area in the included diagram enables the following described functionality:

3^{rd} claim area Ser. No. 10/709358 FIG. 1 bottom row description left to right: This area is carried over from the first two method patent applications that used Groove Network's Groove (since acquired by Microsoft) software framework as an example of how a product inclusive of a forms engine (e.g., Microsoft InfoPath for Biztalk, Groove and Sharepoint) will import the converted proprietary military message sets as XML schemas for temporary storage in the XML Object Store (8) until needed as monitored by the intrinsic state management engine (7) prior to onward distribution or relay by the XML Object Relay (9) that is descriptive of the Microsoft Groove framework. One of the Department of Homeland Security major projects is based upon Groove Technology and has been deployed to the local/city level (DHS JRIES-HISN) thus setting the stage for the Heartbeat Beacon.

FIG. 1, 3^{rd} claim area Ser. No. 10/709358 beneath the framework box description left to right: Database/Joint Common Data Base: database technology for storage and non-real time replication/dissemination of XML tagged data timed by the heartbeat protocol. Geospatial Information Systems (GIS): the category of enterprise infrastructure that would display/process heartbeat temporally timed event data drawn from common symbol—XML repositories. The GIS interacts with the object stores (8)/object relay (9) as managed by the state management engine (7) of the Heartbeat Beacon solution.

FIG. 1 lower right: the box labeled cellular, wireless, satellite with the radio Global Positioning System (GPS) label: military tactical radios like commercial telecommunication cell/smart phones, laptops and handhelds include GPS chips for the geographic location information that is part of what the heartbeat protocol harvests to determine unit/individual platform status (e.g., straggler, halt, moving, stale, or offline). This state data is harvested by sensor nets - military or commercial (e.g., the indicated Transducer Data Exchange Protocol TXDP & ZigBee 802.15.4 that both ride and make use of the heartbeat protocol).

TABLE 1
.mil/.com terms

| Military .mil domains | Homeland Security, .com .org .gov |
|---|---|
| Platforms belonging to Moving Unit execute the Effective DTG. | Router multi-cast groups change |
| | as organizational structure changes |
| C2R/LDIF: Command Control Registry/LDAP Data Interchange Format- the master “address | LDAP: Lightweight Directory Access |
| book” files that reside on each C4I system to properly route tactical messages between nodes. | Protocol - a networking protocol for querying and |
| | modifying directory services running over TCP/IP. |
| Doctrinal multicast groups. Subscribes to Communities of Interest or COI's e.g., intelligence, | Multicast groups by domain segment or |
| operations, medical, field artillery . . . | by formal agreement (e.g., transportation, security, |
| | users by type, service, agency etc) |
| FBCB2: Force XXI Battle Command Brigade and Below & Blue Force Tracker - BFT vehicle | Commercial equivalent systems usually |
| terrestrial radio/satellite enabled versions are a digital command & control system. FBCB2 | focus on a single device or platform. SPRINT recently |
| allows units to see own geospatial location, where the enemy is, where unit members are | announced their family locator service where |
| displayed on an electronic map. A system comprised of rugged laptop computers and | the member's phone can be viewed on another phone |
| communications software that uses radio & satellite links to form a wireless battlefield internet. | or laptop. Provides safety checks to ensure |
| | members reach destinations on time & |
| | one click texting or phone connections. |
| FFIRNs: Federal Field Item Reference Numbers & FUDNS (Field Unit Number Designators) | Equivalent XML tags residing in |
| three and four digit codes field descriptors in structured military message standards | Federal XML Registries |
| Heart Beat process incorporates the UTR command into the periodic Heartbeat message. This | “Stragglers” i.e., RFID tagged package(s), |
| becomes the method by which “stragglers” or “stale” platforms re-affiliate/maintain network | travelers, prisoners . . . not shipped/departed |
| configuration synchronization | from a checkpoint or pattern is erratic. |
| | Deviation from schedule exceeding parameters. |
| | Stale - no reports received for reporting period |
| Moving unit, gaining unit of action, platform tethering, untethering to radio nodes/satellite | Platform or user/handoff subscriber node e.g., |
| | cell tower to tower. |
| ORG ID - Organizational Identification Number FMIDS Force Management Identification | TBD or URN (see URN) |
| Designators to allow data integration & JSIC- Joint System Identifier Codes | |
| Synchronization Delta Time Block “Sync Delta”: time frame e.g., 5 seconds - 15-99 minutes | Time when moving or traveling group executes |
| for heartbeat beacon/data refresh | network changes that change data distribution |
| | routes in supporting router via MIB update |
| TIMS: Tactical Internet Information Management System- the system used to plan, design, and | Router/Switch & network infrastructure |
| configure the digital communication systems and networks (Tactical Internet) between different | configuration tools e.g., to configure router |
| battlefield platforms/devices/nodes | Management Information Bases (MIBS) & multicast |
| | group subscriptions e.g., Juniper Networks CESAC: |
| | Command Enterprise Situational Awareness |
| Uniform Resource Name: URNs identify resources over their entire life span. Since URNs | Uniform Resource Name: URNs identify resources |
| (contrary to URLs) are independent of the place or other characteristics of resources, a URN can | over their entire life span . . . |
| be maintained, even if the physical place of resources changes. | |
| UTO: Unit Task Organization- hierarchy of parent/subordinate units (command and support | Corporate management hierarchy chart realizing |
| relationships) with assigned equipment and personnel. A UTO is created by tailoring a force of | that the .com domain does not normally |
| different types of units and equipment to meet the needs of a particular tactical mission. | reorganize daily, weekly, monthly adhoc to |
| | temporarily complete a given mission/corporate |
| | goal e.g., reacting to being targeted by terrorists. |
| UTR (U = Unit, T = Task, R = reorganization) command is broadcast to the entire net/subnet for | Method where platform/user state |
| execution UTR = Unit Task Reorganization modified = Heartbeat XML network (re) | information (location, current IP lease, |
| configuration message sent containing data changing router Management Information Bases | subnet affiliation, type of device/platform |
| (MIBS) that change participation in multicast groups subscriptions reflecting organization | identification number - see ORG ID & JSIC & URN |
| structure. Enables military to join first responder nets and vice verse on an adhoc basis. | on the military side of equation), SSID on |
| | commercial WiFi networks, cell phone number, |
| | customer number and multicast subscription(s) |
| | e.g., sports news, family locator affiliations |
| | or “in groups” |
| Table 1: Left Side: Military unique awareness terms compared with | Right Side: commercial equivalent terms |

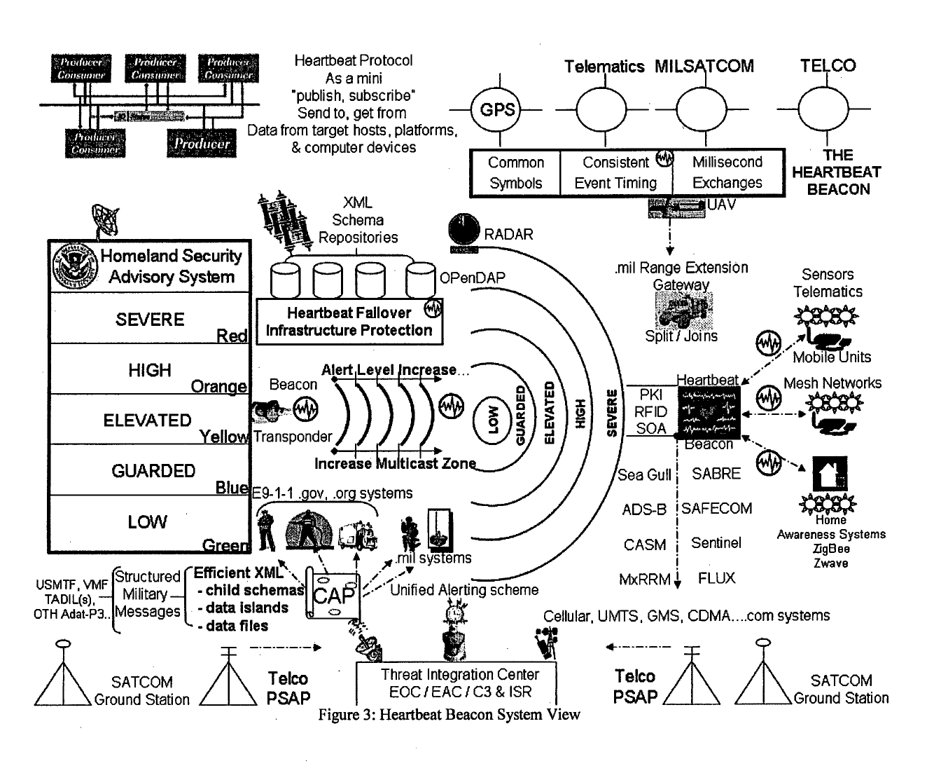

FIG. 3 lower left hand corner: the Heartbeat K00.99 network configuration message initiates a sequence whereby other data dissemination messages are spawned stimulating operational, intelligence, logistics etc data cascades on the military side of the Heartbeat Beacon equation. A commercial equivalent heartbeat message is needed to instantiate emergency message data cascades on the commercial, organizational side of the equation. The Common Alert Protocol—CAP goal to provide “a standard method to collect and relay instantaneously and automatically all types of hazard warnings and reports locally, regionally and nationally for input into a wide variety of dissemination systems” must be designed in a manner that is backwards compatible with current FBCB2/Blue Force Tracking equipped units and forward compatible with Future Combat Systems equipped units that both employ the heartbeat protocol and heartbeat XML network configuration messages.

FIG. 3, right center: Radio Frequency Identification RFID where RFID tags if the active type, send data to a network monitoring/relay that sends the date time stamp, service provider or organization data, GPS derived location etc as harvested by the TCP/IP primitive heartbeat mechanisms (center) to a threat integration center (bottom center) via router/switches applying the principles behind Blue Force Tracking (BFT) (e.g., filtering applying business rules (mission thread logic in military speak) and FBCB2. If a passive RFID tag, then the data and logic to process that data is contained is harvested by application of the TCP/IP send to, get from functions, as timed by the timing function that serves as a trigger to send the harvested data to the monitoring station for onward distribution heeding stored business logic (mission threads in military parlance) filtering methodology and procedures. The application layer logic as carried out by scripts, methods or procedures performs the requisite association of the three and four digit codes that correspond to symbology derived from message data elements that correspond to geospatial symbols applied by geospatial applications such as the Joint Common Mapping Toolkit—JMTK. The result of this methodology is that RFID tagged packages, devices or humans wearing RFID tagged bracelets will automatically generate situational awareness data that is granular to ten digit GPS location data and individual platforms and equipment vice general geometric areas of interest and non-GPS derived location data characteristic of the Common Alert Protocol current design.

The Heartbeat Beacon describes a methodology to “maneuver the network” (change router databases to support maneuvering units) enhanced by beacon transponder technology & made interoperable by adapting the procedures to the world wide OASIS standards body & presidential ratified Common Alert Protocol—that is not linked with military NCW data exchanges hence Heartbeat Beacon's notion of CAP child schemas to account for (commercial) domain specific business rules analogous to structured military message mission threads. Heartbeat Beacon methodology connects military domains with commercial/first responder chop chains (workflows). Example: NORAD track data processed by e9-1-1 Public Safety Answering Points—PSAPS is distributed only through the 80% of the commercial network but not the 20% of the military organic assets where systems controlling fast movers & air defense assets operate that is a disconnect (e.g., the 9/11 scenario where commercial jets . . . )

The Heartbeat Beacon addresses the interoperability challenge where unique & proprietary Federal/military situational awareness (SA) systems // commercial heartbeat beacon based systems (e.g., GM's OnStar // Telco e9-1-1 Public Safety Answering Point—PSAP networks supporting First Responder e9-1-1 systems agree on common, consistent settings of three common building blocks. Differences between domains (e.g., military, commercial, and first responder types—fire, police, EMT etc can be addressed by Common Alert Protocol designed child schemas and or data islands as encoded as Efficient XML developed by AgileDelta in cooperation with the World Wide Web Consortium—W3C to address mobile computer devices with relatively low bandwidth support and processing power. By standardizing on the three common building blocks, consistent timing, common symbology, and millisecond range data transactions can be achieved across both military and first responder “system of systems”. Heartbeat Beacon methodology (center right) involves using the heartbeat protocol as a common timing pulse/trigger to get data from target devices & platforms (e.g., cell phones, smart phones, laptops, sensors) for onward dissemination by any more modern & powerful protocols I systems that often themselves rely on the heartbeat protocol e.g., NASA/Jet Propulsion Laboratorie's OPenDAP. Middle Center below heartbeat icon: existing or systems under development such as OPenDAP, SABRE, Sentinel, Sea Gull, CoCo protocol . . . can be applied to manage the network infrastructure supporting battlefield methodology at a supportable cost. (see acronyms)

Center left to right: The DHS Homeland Security Advisory system with its five colored levels can serve as a framework to broadcast alerts based on exceeding defined thresholds (e.g., number of alerts per zone or the severity of the alert such as earthquake magnitude). The capability of beacon technology based Sea Gull to multicast with increasing radius can be used to shape evacuations of population within zones or conversely, call in first responder and military assets that are being “spontaneously integrated” for the task at hand in the manner that Paul Revere used near Boston several hundred years ago to rally against the British invasion—in other words, history repeats itself. Sea Gull beacon technology maintains routing and object state using minimal resources. e.g. less than 1% of bandwidth and CPU cycles of the network & networked devices. By increasing the reporting period or decreasing the frequency with the routing level, its data-driven server heartbeat's “keep-alive” multicasts to all ancestors with an object pointer that points to the server heartbeat is used to tailor multicast zone increases or decreases. Sea Gull multicasts with increasing radius by sending the server heartbeat's “keep-alive” beacon along each forward link -corresponding to increasing threat levels increasing the multicast zone given frequency of incident reporting, the estimated scope of the event . . . corresponding to the color coding alert scheme by concentric color bands.

This right hand center of figure 3 shows home mesh network technology such as the Eaton Home Heartbeat is part of the Zigbee Alliance applying the Zigbee protocol along with over 100 other firms. Z-Wave is a similar mesh network protocol applying the heartbeat with an industry alliance. There are 70+competing standards for mesh networking—hence the needs to focus on common denominators like the heartbeat protocol to promote commonality & interoperability.

Sensor Telematics such as General Motor's OnStar supports mobile sensor equipped vehicles and fleets. OnStar began as “Project Beacon” in 1994—upper right center FIG. 3.

1. A method of claim wherein a fully commercialized methodology of the military's Network Centric Warfare (NCW) situational awareness generating operational procedures described in Ser. Nos. 10/605144, 10/708000, and 10/709358 that collectively describe methods centered on three common denominators/building blocks that will collectively enable method to enable the Heartbeat Beacon
(1) Common denominator one: The common, consistent, universal method of applying the TCP/IP heartbeat protocol/heartbeat beacon/beacon frames used as an intrinsic timer for data harvesting of user and network state management information such as:
current/active data such as: IP lease, location, Universal Resource Number URN
state information that can determine if computer device is moving, at halt, or a straggler that is harvested then distributed to queues, file folders, object stores and other temporary storage means by TCP/IP heartbeat's publish-subscribe functions (get from, send to)
This listed data/information is gathered by the TCP/IP heartbeat protocol for retrieval and dissemination by n number of more modern and more capable applications, products or protocols (e.g., TDXP, 802.11s ESS, ZigBee IEEE 802.15.4, Z-Wave type wireless mesh networks, Groove bots, JXTA motes, intelligent agents and beacon protocol technologies such as Sea Gull, SENTINEL, Flux Beacon, SABRE . . . )
(2) Common Denominator two: Heartbeat Beacon network (re) configuration messages/forms/schemas/child schemas and or data islands embedded in the XML schemas to include the use of a binary encoding scheme such as QUALCOMM's Binary RunTime Environment for Windows (BREW) or AgileDelta's Efficient XML to address small data files sent to high speed mobile computer devices in the millisecond range
(3) Common Denominator three: Common Alert Protocol—CAP child schemas and or embedded data islands implemented across x complex systems, y federal, state and local contracts, and z product, operating system, network and system types in a standard, non-proprietary and non-military unique method

2. A method of claim where the second building block/common denominator is Heartbeat XML network management messages containing TCP/IP's intrinsic get from/send to functions the state management data necessary for network (re) configuration of unicast/multicast subscription groups representing task (re) organization of unit/organizations typical of router/switch and IP/PBX, software PBX (private branch exchange) supported networks thus permitting “spontaneous (re) organization of disparate types of organizations.

3. A method of claim where the third building block/common denominator is the Common Alert Protocol child schema/messages compliant with the Emergency Data Exchange Language Distribution Element EDXL-DE standard that may also include DoD Discovery Metadata Standard—DDMS elements as Efficient XML encoded data islands in child schema or as data islands within the main CAP schema designed to trigger data exchange cascades/harvesting to/from disparate stakeholder domains (e.g., .mil, .gov, .edu, .com, .biz, .net, .org.).

4. A method of claim wherein aggregated state data elements derived from converted structured military messaging FFIRNs and FUDNs into equivalent X.ML tags in CAP XML (child) schemas will now be parsed by commercial forms engines with intrinsic message parsers enabling the ability to resolve to the individual platform level (e.g, vehicle, plane, train) describing situational conditions symbolically e.g., “state”, “straggler”, and under duress platforms of interest/commercial subscribers vice a general geographic area of interest as is the state of the current Common Alert Protocol—CAP OASIS standard that is separate and distinct from military equivalent standards.

5. A method of claim whereas the Common Alert Protocol—CAP equivalent of the Army's Unit Task Order—UTO heartbeat (field order) message described by the table in this application that describes the key parameters that enable FBCB2-BFT and their commercial equivalent platforms to receive/transmit current active situational awareness data—who, what, where, when, how often at a later time if platforms of interest (e.g., GPS equipped handheld, laptop or smart phones) conditions e.g., out of radio range, turned off, or down for maintenance or in a duress condition at the time of the initial or follow on heartbeat timed data collection interval (e.g., stale, straggler).

6. A method of claim where DOD, Service and Agency XML repositories supply data element repository for a national/international “Heartbeat Beacon” system of systems accessing these XML repositories such as NEIM, JXDM, DDMS, OpenGIS OGC in EDXL-DE format compliant tags.

7. A method of claim where eXtensible markup language (XML) wrapper exposes the military discovery metadata to a web portal for screen refresh/updating faster (e.g, milliseconds, seconds) than the current referenced thirty seconds web portal refresh timing rate quoted in this application's referenced AFCEA Signal Magazine article due to direct schema/message/form exchanges by employing Efficient XML encoded technology for small data files designed to support millisecond data exchanges over very low bandwidth links and minimal CPU power.

8. A method of claim where the above described CAP child schemas with optional DDMS formatted data islands are jointly designed by Federal e9-1-1, public safety and military standards bodies for implemented
Through the telecommunication Public Safety Answering Points (PSAPs) of the (inter) national and relevant public safety, infrastructure protection systems
as requirements in federal contracts such as the General Service Administration's NETWORX & Alliant Contracts, Department of Justice Integrated Wireless Network—IWN, DHS EAGLE/First Source, Defense Information System Agency Encore II, . . . ) and other federal and commercial infrastructure provider contracts that typically contain both telecommunication and situational awareness requirements.

9. A method of claim wherein the agreed upon standards shall. enable multicast subscription services accessible by neighborhood watch programs, local first responder units equipped with GPS smart phones, personal digital assistants, and laptop computer devices linked via transponder heartbeat beacon technology that increases/decreases the multicast radius corresponding to the DHS threat condition criteria to enable military and first responders to operate in an adhoc, spontaneous fashion following military inspired network centric warfare tactics, techniques and procedures that implement adhoc organizational network affiliation split, joins based on unique unit/organization identification such as the Uniform Resource Name URN/Organizational Identification Number or as alternatively identified in our (inter) national response plans.
